(19) United States
(12) Patent Application Publication
(10) Pub. No.: US 2009/0237955 A1
(43) Pub. Date: Sep. 24, 2009

(54) OPTICAL DEVICE AND IMAGE EXPOSURE APPARATUS

(75) Inventor: Atsushi MUKAI, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/409,112

(22) Filed: Mar. 23, 2009

(30) Foreign Application Priority Data
Mar. 21, 2008 (JP) 2008-074027

(51) Int. Cl. H01S 3/00; H01S 3/30

(52) U.S. Cl. 362/553; 372/5

(57) ABSTRACT

A window of a CAN package is sealed by a circular transparent plate member and a cylindrical transparent member. The diameter of the cylindrical transparent member is equal to the diameter of the window, and the thickness thereof is 1 mm. The distance from a semiconductor laser LD to a light output surface of the circular transparent member is approximately 1 mm, and the distance from the semiconductor laser LD to a light output surface of the cylindrical transparent member is approximately 2 mm. The output of the semiconductor laser LD is 800 mW, and the transmittance area of a laser beam at the light output surface of the transparent member is approximately 0.70 mm² (1/e). The light density at the light output surface of the transparent member is 1.14 (W/mm²). Deterioration in transmittance rates can be suppressed if the light density at the light output surface of the transparent member is 1.15 or less.

### BACKGROUND OF THE INVENTION

1. Field of the Invention

The present invention is related to an optical device equipped with a light emitting means in which a light emitting element is sealed in a sealing portion. The present invention is also related to an image exposure apparatus that employs the optical device.

2. Description of the Related Art

A conventional optical device that focuses a light beam emitted from a light source with an optical system and causes the light beam to enter an optical fiber is illustrated in FIG. 16. In this optical device, a transparent member 503, of which the side facing a light source 501 is cut obliquely, is placed in the optical path of a light beam which is emitted from the light source 501 and focused by a focusing lens 502. An optical contact is established between the side (light output surface) of the transparent member 503 which is not cut obliquely and an optical fiber 505. This configuration reduces noise caused by light, which is reflected at light input surfaces of optical fibers, returning to light sources.

However, in the above conventional optical device, surfaces of the components provided in the optical path which are exposed to the atmosphere, for example, the light input surface 504 of the transparent member 503 illustrated in FIG. 16, become contaminated by matter such as dust being attached thereto. This causes a problem that the light output from an output end surface of the optical fiber 505 decreases. Particularly in cases that the wavelength of emitted light is less than or equal to 500 nm, the light energy is great, and easily influenced by contamination. In addition, the rate of decrease of the light output becomes greater as the light density of the light that passes through the contaminated surface increases.

The present inventors investigated to find to what degree the light density of light that passes through the light input surface 504 which is exposed to the atmosphere needed to be decreased in order to suppress the decrease in light output caused by contamination. As a result of the investigation, it was discovered that a linear correlative relationship exists between the degree of decrease in output and the light density of the light that passes through the light input surface 504 (refer to Japanese Patent Application No. 2007-121102). This relationship will be described below.

The present inventors focused a laser beam emitted from a laser 501 driven within a range of 50 mW to 400 mW with a lens 502 such that a predetermined power density was obtained. A transparent member 503 formed of glass was placed in the vicinity of the focal point of the laser beam, and the transmittance rate of the laser beam over time was measured. In addition, measurements were repeatedly performed while changing the light density at a light input surface 504, by moving the transparent member 503 along the optical axis of the laser beam.

The results of the above experiment are illustrated in FIG. 17. The horizontal axis represents the light density (W/mm²) of the laser beam at the light input surface 504 of the transparent member 503. The vertical axis represents the degree of output decrease of light output due to contamination, that is, the rate of output decrease of the laser beam which has passed through the transparent member 503 per hour. Note that in FIG. 17, the circles indicate actual measured values, and the line illustrated in the graph was derived by the method of least squares. The following formula represents the line.

Log R=−6.5+0.9·Log(P/S) (1)

Here, R is the rate of output decrease due to contamination of the light input surface of the transparent member 503 per hour (/hour), P is the output value (W) of the laser beam, and S is the transmittance area (mm²) of the laser beam at the light input surface of the transparent member.

Here, the lifetime of a laser element is defined as the point in time at which the output of the laser element decreases from a predetermined output by 20%. In the case that a laser element having a lifetime of 10000 hours is utilized, it is desirable for the decrease in output due to contamination until the end of the element's life is 1/10 or less the decrease in the output of the laser element, that is, 2% or less. For this reason, the allowable rate of output decrease (/hour) is 0.02/10000=2.0·10⁻⁶. According to the graph of FIG. 17, the light density that corresponds to this value is 8 (W/mm²).

Accordingly, in the configuration illustrated in FIG. 16, the decrease in light output caused by contamination can be suppressed by causing the light density at the light input surface 504 of the transparent member 503 to be 8 (W/mm ) or less. Specifically, factors such as the output value of the light source 501, the magnification rate of the lens 502, the length of the transparent member 503 in the direction of the main axis of the laser beam, and the refractive index of the transparent member 503 are set such that the light density at the light input surface 504 of the transparent member 503 becomes 8 (W/mm²) or less.

Recently, developments in CAN package type light sources, in which light emitting elements that emit light having wavelengths of 500 nm or less are housed, are advancing. There are known light sources of this type which are capable of obtaining output of several hundred mW. The present inventors attempted to utilize a CAN package type light source as the light source of the aforementioned optical device. Transparent members are provided in windows of CAN package type light sources. At first, the present inventors assumed that the relationship between the light density at the window and the degree of deterioration of transmittance rates through the windows is substantially the same as the experimental results disclosed in Japanese Patent Application No. 2007-121102. A CAN package type light source, in which the light density is 4.5 (W/mm²) at the window, was utilized and driven experimentally for 10000 hours.

However, when the CAN package type light source was driven for 10000 hours, it was found that the deterioration of transmission rate through the window was greater than expected. From this, it became clear that the light density of 4.5 (W/mm) at the window was too great. However, it was unclear to what degree the light density needed to be decreased in order to suppress the deterioration of transmittance rate through the window. Accordingly, there was a problem that the reliability of the optical device having this configuration would be adversely affected.

### SUMMARY OF THE INVENTION

The present invention has been developed in view of the foregoing circumstances. It is an object of the present invention to provide an optical device equipped with a light emitting means, in which a light emitting element is sealed in a sealing portion, and a window, in which a transparent member is provided, which is capable of suppressing deterioration of the transmittance rate through the transparent member in the window even if driven for long periods of time. It is another object of the present invention to provide an image exposure apparatus that employs the optical device.

An optical device of the present invention comprises:

light emitting means constituted by: a light emitting element that emits a light beam having a wavelength within a range from 220 nm to 500 nm at an output of 230 mW or greater; a housing having a window that contains the light emitting element in a sealed state therein; and a first transparent member, which is transparent with respect to the light beam, that seals the window; and

a focusing optical system that focuses the light emitted by the light emitting element and output through the first transparent member; and is characterized by:

the light density of the light beam being 1.15 W/mm² or less at the light output surface of the first transparent member.

Note that here, “an output of 230 mW or greater” refers to the peak value of the output is 230 mW or greater, regardless of whether the light beam is emitted as pulses or a continuous wave. The “light emitting element that emits a light beam having a wavelength within a range from 220 nm to 500 nm” refers to the peak wavelength of the light beam emitted from the light emitting element being 220 nm or greater and 500 nm or less. The “light output surface of the first transparent member” is a facet of the first transparent member, from which the light beam is output to the exterior of the light emitting means.

The first transparent member may be fitted into the window, and protrude toward the exterior of the housing.

Alternatively, the first transparent member may abut the housing at the exterior thereof.

The optical device may further comprise:

an optical fiber provided such that the light which is focused by the focusing optical system enters thereinto. The optical fiber may be formed from quartz.

The optical device may further comprise:

a second transparent member, which is transparent with respect to the light beam, provided between a light input surface of the optical fiber and the focusing optical system. In this case, the optical fiber may be configured to be removably attached to the second transparent member, and optically positioned by abutting the second transparent member.

The optical device may further comprise:

a coupling preventing film formed by a fluoride material and having a thickness less than or equal to 1/12 the wavelength of the light beam, provided on one of the light output surface of the second transparent member and the light input surface of the optical fiber.

The light emitting element may be a semiconductor laser. The light emitting means may be a 9 mm diameter CAN package that houses the semiconductor laser.

The wavelength of the light beam emitted by the light emitting element may be within a range from 370 nm to 500 μm. Alternatively, wavelength of the light beam emitted by the light emitting element may be within a range from 400 nm to 410 nm.

An image exposure apparatus of the present invention is characterized by being equipped with the optical device of the present invention as an exposure light source.

The optical device of the present invention comprises: the light emitting means constituted by: the light emitting element that emits a light beam having a wavelength within a range from 220 nm to 500 nm at an output of 230 mW or greater (an output having peak values of 230 mW or greater regardless of whether the light beam is emitted as pulses or as a continuous wave); the housing having a window-that contains the light emitting element in a sealed state therein; and the first transparent member, which is transparent with respect to the light beam, that seals the window; and the focusing optical system that focuses the light emitted by the light emitting element and output through the first transparent member. The optical device of the present invention is characterized by the light density of the light beam being 1.15 W/mm² or less at the light output surface of the first transparent member. Therefore, deterioration in the transmittance rate at the light output surface of the first transparent member can be suppressed, even if the optical device is driven for a long period of time.

The first transparent member may be fitted into the window, and protrude toward the exterior of the housing. In this case, the distance from the light emitting element to the light output surface of the first transparent member increases. Therefore, the light density of the light beam at the light output surface of the first transparent member can be caused to be 1.15 W/mm or less, without increasing the size of the optical device.

Alternatively, the first transparent member may abut the housing at the exterior thereof. In this case, the distance from the light emitting element to the light output surface of the first transparent member increases. Therefore, the light density of the light beam at the light output surface of the first transparent member can be caused to be 1.15 W/mm² or less, without increasing the size of the optical device. In addition, the area of the light output surface of the first transparent member can easily be set to be greater than the area of the window. Therefore, the degree of freedom in designing the window is improved.

The optical device may further comprise: the optical fiber provided such that the light which is focused by the focusing optical system enters thereinto. In this case, the light beam emitted by the light emitting element can be efficiently propagated through the optical fiber.

The optical device may further comprise: the second transparent member, which is transparent with respect to the light beam, provided between a light input surface of the optical fiber and the focusing optical system, and the optical fiber may be configured to be removably attached to the second transparent member, and optically positioned by abutting the second transparent member. In this case, positioning of the optical fiber can be facilitated.

The optical device may further comprise: the coupling preventing film formed by a fluoride material and having a thickness less than or equal to 1/12 the wavelength of the light beam, provided on one of the light output surface of the second transparent member and the light input surface of the optical fiber. In this case, fusion at the surface where the second transparent member and the optical fiber abut each other can be prevented.

The image exposure apparatus of the present invention is characterized by being equipped with the optical device of the present invention as an exposure light source, which is capable of suppressing deterioration in the transmittance rate at the light output surface of the first transparent member, even if driven for a long period of time. Therefore, the reliability of the image exposure apparatus during use for a long period of time is improved.

### BRIEF DESCRIPTION OF THE DRAWINGS

FIG. 1 is a sectional side view that illustrates the schematic structure of an optical device according to a first embodiment of the present invention.

FIG. 2 is a graph that illustrates the relationship between the degree of decrease in output and the light density of light that passes through the light input surface of a transparent member.

FIG. 3 is a sectional side view that illustrates the schematic structure of an optical device according to a second embodiment of the present invention.

FIG. 4 is a sectional side view that illustrates the schematic structure of an optical device according to a third embodiment of the present invention.

FIG. 5 is a sectional side view that illustrates the schematic structure of an optical device according to a fourth embodiment of the present invention.

FIG. 6 is a perspective view that illustrates the outer appearance of an image exposure apparatus according to an embodiment of the present invention.

FIG. 7 is a perspective view that illustrates the construction of a scanner of the image exposure apparatus of FIG. 6.

FIG. 8A is a plan view that illustrates exposed regions, which are formed on a photosensitive material.

FIG. 8B is a diagram that illustrates the arrangement of exposure areas exposed by exposure heads.

FIG. 9 is a perspective view that illustrates the schematic construction of an exposure head of the image exposure apparatus of FIG. 6.

FIG. 10 is a schematic sectional view that illustrates the exposure head of the image exposure apparatus of FIG. 6.

FIG. 11 is a partial magnified diagram that illustrates the construction of a digital micro mirror device (DMD).

FIG. 12A is a diagram for explaining the operation of the DMD.

FIG. 12B is a diagram for explaining the operation of the DMD.

FIG. 13A is a plan view that illustrates the scanning trajectories of exposing beams in the case that the DMD is not inclined.

FIG. 13B is a plan view that illustrates the scanning trajectories of the exposing beams in the case that the DMD is inclined.

FIG. 14A is a perspective view that illustrates the construction of a fiber array light source.

FIG. 14B is a front view that illustrates the arrangement of light emitting points of laser emitting portions of the fiber array light source.

FIG. 14C is a diagram that illustrates the configuration of optical fibers.

FIG. 15 is a block diagram that illustrates the electrical configuration of the image exposure apparatus of FIG. 6.

FIG. 16 is a diagram that illustrates the schematic structure of a conventional optical device.

FIG. 17 is a graph that illustrates the relationship between the degree of decrease in output and the light density of light that passes through the light input surface of a transparent member.

### BEST MODE FOR CARRYING OUT THE INVENTION

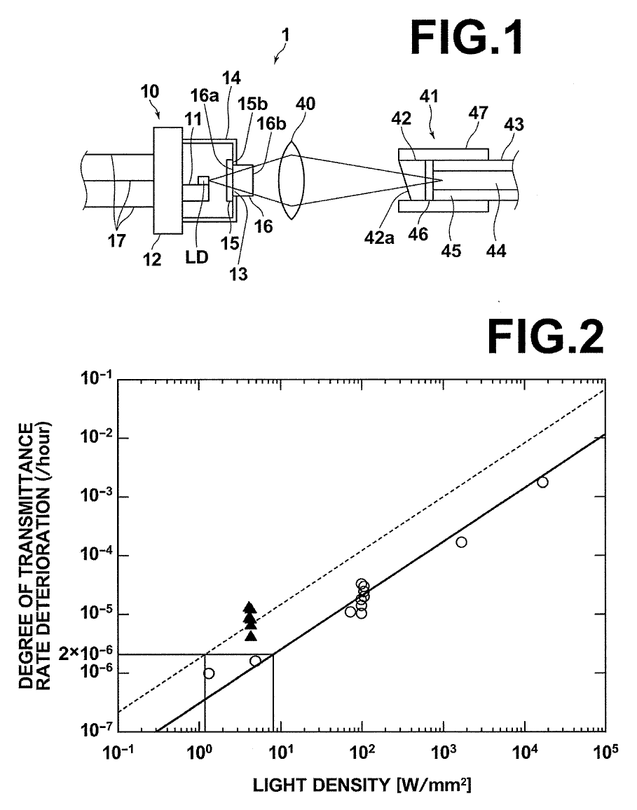

Hereinafter, an optical device 1 according to a first embodiment of the present invention will be described with reference to the attached drawings. FIG. 1 is a sectional side view that illustrates the schematic structure of the optical device 1 of the first embodiment.

As illustrated in FIG. 1, the optical device 1 is constituted by: a CAN package 10 having a diameter of 5.6 mm, in which a GaN semiconductor laser LD having an output of 800 mW is hermetically sealed; a focusing lens 40 for focusing a laser beam B (light beam B) emitted by the GaN semiconductor laser LD; a cylindrical transparent member 42, provided such that the laser beam B which has passed through the focusing lens 40 enters thereinto; an optical fiber 43, into which the laser beam B which has passed through the transparent member 42 enters; and an optical fiber module 41 equipped with a sleeve 47 for holding the transparent member 42 and the optical fiber 43. Note that the CAN package 10 functions as the light emitting means of the present invention.

The light emission shape of the semiconductor laser LD is 7·1 μm². The horizontal radiation angle is 42 degrees, and the vertical radiation angle is 18 degrees. The semiconductor laser LD is fixed on a block 11 within the CAN package 10 by AuSn brazing material. The block 11 is fixed to a fixing member 12. A metal case 14 having a circular window 13 is fixed to the fixing member 12 by resistance welding. The window 13 is sealed by a circular transparent plate member 15 and a cylindrical transparent member 16. The circular transparent plate member 15 and the cylindrical transparent member 16 are formed by glass having Si and O as the main components thereof, such as quartz glass and borosilicate glass. The transparent member 15 is adhesively attached to the case 14 at the interior thereof. The diameter of the cylindrical transparent member 16 (the dimension in the vertical direction in FIG. 1) is equal to the diameter of the window 13, and the thickness thereof (the dimension in the horizontal direction in FIG. 1) is 1 mm. Note that the distance from the semiconductor laser LD to a light output surface 15b of the transparent member 15 is 1 mm. Because the thickness of the transparent member 16 is 1 mm, the distance from the semiconductor laser LD to a light output surface 16b of the transparent member 16 is approximately 2 mm. The transmittance area of the laser beam B at the light output surface 16b of the transparent member 16 is approximately 0.70 mm² (1/e).

The end of the transparent member 16 toward a light input surface 16a thereof is inserted into the window 13 and abuts the light output surface 15b of the transparent member 15. The end of the transparent member 16 toward the light output surface 16b protrudes toward the exterior of the case 14. An anti reflective coating process is administered onto the light input surface 15a of the transparent member 15, but not on the light output surface 15b. An anti reflective coating process is administered onto the light input surface 16a of the transparent member 15, but not on the light output surface 16b. Wires 17 and the like for supplying drive current to the semiconductor laser LD are drawn out from the CAN package 10 through openings which are formed in the fixing member 12. Note that the CAN package 10 is deaerated to remove volatile components, filled with an inert gas, then hermetically sealed.

Note that the fixing member 12 and the case 13 function as the housing of the present invention, and the transparent member 16 functions as the first transparent member of the present invention.

The lens 40 focuses the laser beam B output from the CAN package 10 onto a spot in the vicinity of the surface at which the transparent member 42 and the optical fiber 43 abut each other, at a predetermined magnification rate (4×, for example). Note that the focal position of the laser beam B is shifted from the abutment surface along the axis of the laser beam B, and is-either within the optical fiber 43 or within the transparent member 42.

The optical fiber 43 is constituted by a core 44, which is formed by quartz glass, for example, and a cladding 45 provided around the core 44. Note that the transparent member 42 has an outer diameter greater than the beam diameter of the laser beam B that passes therethrough. That is, the transparent member 42 is configured such that the laser beam B is not obstructed.

The outer diameter of the transparent member 42 is equal to the outer diameter of the optical fiber 43. A light input surface 42a of the transparent member 42 is cut obliquely such that an angle of 4 degrees is formed with respect to a direction that perpendicularly intersects the axis of the laser beam B. Thereby, the amount of light that returns toward the CAN package 10 can be reduced, and the coupling efficiency with respect to the optical fiber 43 can be improved. Alternatively, an anti reflective coating may be administered onto the light input surface 42a, instead of cutting the light input surface obliquely. This also can reduce the amount of light that returns toward the CAN package 10.

A coupling preventing film 46 having a thickness less than or equal to 1/12 the wavelength of the laser beam B is provided on a light input surface 43a of the optical fiber 43. The material of the coupling preventing film 46 is that which has high transparency with respect to short wavelengths of light (220 nm to 500 nm ). Fluoride materials such as YF₃, LiF, MgF₂, NaF, LaF₃, BaF₂, CaF₂, and AlF₃ are examples of such materials. The coupling preventing film 46 is formed by IAD (Ion Assisted Deposition) coating.

The transparent member 42 and the optical fiber 43 are held by the cylindrical sleeve 47. The transparent member 42 is fixed within the sleeve 47 by adhesive attachment. The optical fiber 43 is inserted into the sleeve 47 so as to abut the transparent member 42. Note that the optical fiber 43 is removable from the sleeve 47. However, the optical fiber 43 may also be fixed within the sleeve 47 if necessary.

As described previously, the present inventors found that that the deterioration of transmission rate through the window of a CAN package due to contamination when the CAN package type light source was driven for 10000 hours was greater than expected. The degree to which the light density needed to be decreased in order to suppress the deterioration of transmittance rate through the window was considered. A CAN package type light source having a semiconductor laser that emits a laser beam with a wavelength within a range from 400 nm to 410 nm housed therein, in which the light density is 4.5 (W/mm²) at the window, was utilized to measure temporal changes in the transmittance rate of the laser beam at the window.

The results of the above experiment are illustrated in FIG. 2. The horizontal axis represents the light density (W/mm²) of the laser beam at the light output surface of a transparent member. The vertical axis represents the degree of decrease in transmittance rate per hour (/hour). Note that the circles indicate actual measured values of the degree of light output decrease due to contamination of a transparent member provided to abut the light input surface of an optical fiber as disclosed in Japanese Patent Application No. 2007-121102. The line illustrated in the graph was derived by the method of least squares. The following formula represents the line.

Log R=−6.5+0.9·Log(P/S) (1)

Here, R is the rate of output decrease due to contamination of the light input surface of the transparent member 503 per hour (/hour), P is the output value (W) of the laser beam, and S is the transmittance area (mm²) of the laser beam at the light input surface of the transparent member.

In the case that foreign matter becomes attached to the window of a CAN package, reflection and scattering at the light output surface of the window increase. The deterioration of transmittance rate due to contamination is greater at the window of the CAN package, compared to the transparent member which is provided to abut the light input surface of the optical fiber. The inventors considered this phenomenon, and discovered several causes of the deterioration. One cause is that if foreign matter becomes attached to the light output surface of the window of a CAN package, the effects of an anti reflective coating cannot be sufficiently obtained, and the reflectance rate at the window increases. In addition, light scattering due to foreign matter attached to the window is another cause of the deterioration in transmittance rate. From these causes, it can be considered that a linear correlative relationship exists between the degree of deterioration of transmittance rate at the window of a CAN package and light density.

Accordingly, it is considered that the relationship between the light density and the degree of deterioration of transmittance rate at the window of a CAN package has the relationship indicated by the dotted line in the graph of FIG. 2, based on the linear relationship indicated by the solid line and measured values indicated by triangles. Note that in this case, the horizontal axis represents the light density (W/mm²) of a laser beam at the light output surface of the window, and the vertical axis represents the degree of output decrease of light output due to contamination, that is, the rate of output decrease of the laser beam which has passed through the window per hour. Note that the following formula represents the dotted line.

Log R′=−5.76+0.9·Log(P′/S′) (2)

Here, R′ is the rate of decrease in transmittance rate per hour, and P is the output value of the laser beam. S′ is the transmittance area (mm²) of the laser beam at the light output surface of the window.

As in the case described in Japanese Patent Application No. 2007-121102, the lifetime of a laser element is defined as the point in time at which the output of the laser element decreases from a predetermined output by 20%. In the case that a laser element having a lifetime of 10000 hours is utilized, it is desirable for the decrease in output due to contamination until the end of the element's life is 1/10 or less the decrease in the output of the laser element, that is, 2% or less. For this reason, the allowable rate of output decrease (/hour) is 0.02/10000=2.0·10⁻⁶. According to the graph of FIG. 2, the light density that corresponds to this value is 1.15 (W/mm²).

In the present embodiment, the output of the semiconductor laser is 800 mW, and the transmittance area of the laser light at the light output surface 16b of the transparent member 16 is approximately 0.70 mm² (1/e). Therefore, the light density at the light output surface 16b of the transparent member 16 is 1.14 (W/mm²).

The present inventors configured the optical device 1 such that the light density at the light output surface 16b of the transparent member 16 is 1.14 (W/mm²) as described above, and performed measurements of transmittance rates. As a result, it was confirmed that deterioration of the transmittance rate was sufficiently suppressed.

Note that the transparent member 16 is fitted into the window 13 and adhesively attached. This simple structure increases the distance from the light emitting element to the light output surface of the first transparent member. Therefore, the light density of the laser beam at the light output surface 16b of the transparent member 16 can be caused to be 1.15 W/mm² or less.

In the case that the transparent member 16 is not provided, the laser beam will be output toward the exterior from the light output surface 15b of the transparent member 15. In this case, the transmittance area of the laser beam through the light output surface 15b of the transparent member is approximately 0.18 mm² (1/e). Therefore, the light density at the light output surface 15b of the transparent member 15 will become 4.5 (W/mm²), which is a great increase.

The optical device 1 according to the first embodiment is equipped with the transparent member 42 and the optical fiber 43. Therefore, the light emitted by the semiconductor laser LD can be efficiently propagated.

The light input surface of the optical fiber 43 is configured to be removably attached to the transparent member 42, and optically positioned by abutting the transparent member 42. Therefore, positioning of the optical fiber 43 is facilitated.

The coupling preventing film 46 is provided on the light input surface 43a of the optical fiber 43. Therefore, fusion at the surface where the transparent member 42 and the optical fiber 43 abut each other can be prevented.

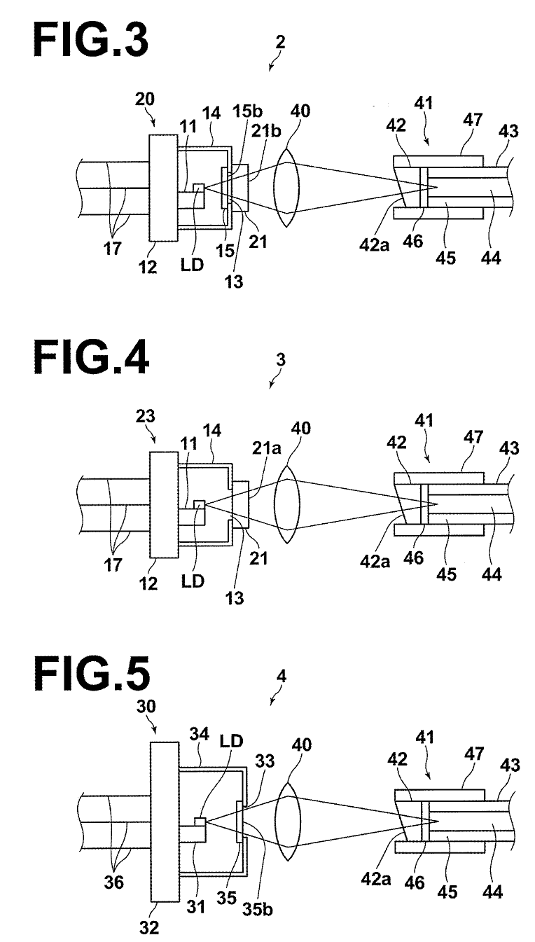

Next, an optical device 2 according to a second embodiment of the present invention will be described. FIG. 3 is a diagram that schematically illustrates the construction of the optical device 2 of the second embodiment. Note that in FIG. 3, elements of the optical device 2 which are the same as those of the optical device 1 are denoted by the same reference numerals, and detailed descriptions thereof will be omitted.

As illustrated in FIG. 3, the optical device 2 of the second embodiment is constituted by: a CAN package 20 having a diameter of 5.6 mm, in which a GaN semiconductor laser LD is hermetically sealed; a focusing lens 40 for focusing a laser beam B emitted by the GaN semiconductor laser LD; and an optical fiber module 41, into which the laser beam B which has been focused by the focusing lens 40 enters.

A window 13 of the CAN package 20 is sealed by a transparent member 15 and a cylindrical transparent member 21. The transparent member 15 and the cylindrical transparent member 21 are formed by glass having Si and O as the main components thereof, such as quartz glass and borosilicate glass. The transparent member 21 abuts and is adhesively attached to a case 14 at the exterior thereof. The thickness of the transparent member 21 is 1 mm. The distance from the semiconductor laser LD to a light output surface 21b of the transparent member 21 is approximately 2 mm. The transmittance area of the laser beam B through the light output surface 21b of the transparent member 21 is approximately 0.70 mm² (1/e).

In the second embodiment as well, the output of the semiconductor laser LD is 800 mW, and the transmittance area of the laser beam B through the light output surface 21b of the transparent member 21 is approximately 0.70 mm² (1/e). Therefore, the light density at the light output surface 21b of the transparent member 21 is 1.14 (W/mm²).

The present inventors configured the optical device 2 such that the light density at the light output surface 21b of the transparent member 21 is 1.14 (W/mm²) as described above, and performed measurements of transmittance rates. As a result, it was confirmed that deterioration of the transmittance rate was sufficiently suppressed.

Note that the transparent member 21 abuts and is adhesively attached to the case 14. This simple structure increases the distance from the semiconductor laser LD to the light output surface 21b of the transparent member 21. Therefore, the light density of the laser beam B at the light output surface 21b of the transparent member 21 can be caused to be 1.15 W/mm² or less. In addition, the area of the light output surface 21b of the transparent member 21 can easily be set to be greater than the area of the window 13. Therefore, the degree of freedom in designing the window 13 is improved.

Next, an optical device 3 according to a third embodiment of the present invention will be described. FIG. 4 is a diagram that schematically illustrates the construction of the optical device 3 of the third embodiment. Note that in FIG. 4, elements of the optical device 3 which are the same as those of the optical device 1 are denoted by the same reference numerals, and detailed descriptions thereof will be omitted.

As illustrated in FIG. 4, the optical device 3 of the third embodiment is constituted by: a CAN package 23 having a diameter of 5.6 mm, in which a GaN semiconductor laser LD is hermetically sealed; a focusing lens 40 for focusing a laser beam B emitted by the GaN semiconductor laser LD; and an optical fiber module 41, into which the laser beam B which has been focused by the focusing lens 40 enters.

The CAN package 23 is the CAN package 20 of FIG. 3, from which the transparent member 15 has been removed. Therefore, a single transparent member 21 can be utilized to cause the light density of the laser beam B at the light output surface 21b of the transparent member 21 to be 1.15 W/mm² or less. The same advantageous effects as those obtained by the second embodiment can be obtained.

Next, an optical device 4 according to a fourth embodiment of the present invention will be described. FIG. 5 is a diagram that schematically illustrates the construction of the optical device 4 of the fourth embodiment. Note that in FIG. 5, elements of the optical device 4 which are the same as those of the optical device 1 are denoted by the same reference numerals, and detailed descriptions thereof will be omitted.

As illustrated in FIG. 5, the optical device 4 of the fourth embodiment is constituted by: a CAN package 34 having a diameter of 9 mm, in which a GaN semiconductor laser LD is hermetically sealed; a focusing lens 40 for focusing a laser beam B emitted by the GaN semiconductor laser LD; and an optical fiber module 41, into which the laser beam B which has been focused by the focusing lens 40 enters.

The semiconductor laser LD is fixed on a block 31 within the CAN package 30 by AuSn brazing material. The block 31 is fixed to a fixing member 32. A metal case 34 having a circular window 33 is fixed to the fixing member 32 by resistance welding.

The window 33 is sealed by a circular transparent plate member 35. The circular transparent plate member 15 is formed by glass having Si and O as the main components thereof, such as quartz glass and borosilicate glass. The transparent member 35 is adhesively attached to the case 14 at the interior thereof. Wires 37 and the like for supplying drive current to the semiconductor laser LD are drawn out from the CAN package 30 through openings which are formed in the fixing member 32.

The distance from the semiconductor laser LD to a light output surface 35b of the transparent member 35 is approximately 2 mm. The transmittance area of the laser beam B at the light output surface 35b of the transparent member 35 is approximately 0.70 mm² (1/e).

In the fourth embodiment as well, the output of the semiconductor laser LD is 800 mW, and the transmittance area of the laser beam B through the light output surface 35b of the transparent member 35 is approximately 0.70 mm² (1/e). Therefore, the light density at the light output surface 21b of the transparent member 35 is 1.14 (W/mm²).

The present inventors configured the optical device 4 such that the light density at the light output surface 35b of the transparent member 35 is 1.14 (W/mm²) as described above, and performed measurements of transmittance rates. As a result, it was confirmed that deterioration of the transmittance rate was sufficiently suppressed.

The distance from the semiconductor laser LD to the light output surface 35b of the transparent member 35 is increased, simply by employing a case having a large diameter. By this simple structure, the light density at the light output surface 35b of the transparent member 35 is caused to be 1.14 (W/mm²), and the optical device 4 can be produced as low cost.

Note that in the embodiments described above, GaN semiconductor lasers LD were employed as the light emitting elements. Alternatively, lasers that emit light at other wavelengths within the range from 220 nm to 500 nm may be employed. Because the amount of collected dust increases due to high energy within the wavelength range from 220 nm to 500 nm , application of the present invention is effective to prevent attachment of foreign matter.

The present inventors obtained similar results when the optical devices according to the above embodiments were produced using solid state ultraviolet lasers that emit light at a wavelength of 220 nm, using semiconductor lasers as excitation light sources. The wavelength range of the light emitting elements may be within a range from 370 nm to 500 nm, or from 400 nm to 410 nm.

Next, an image exposure apparatus which is equipped with the optical device of the present invention as exposure light sources will be described.

### [Configuration of the Image Exposure Apparatus]

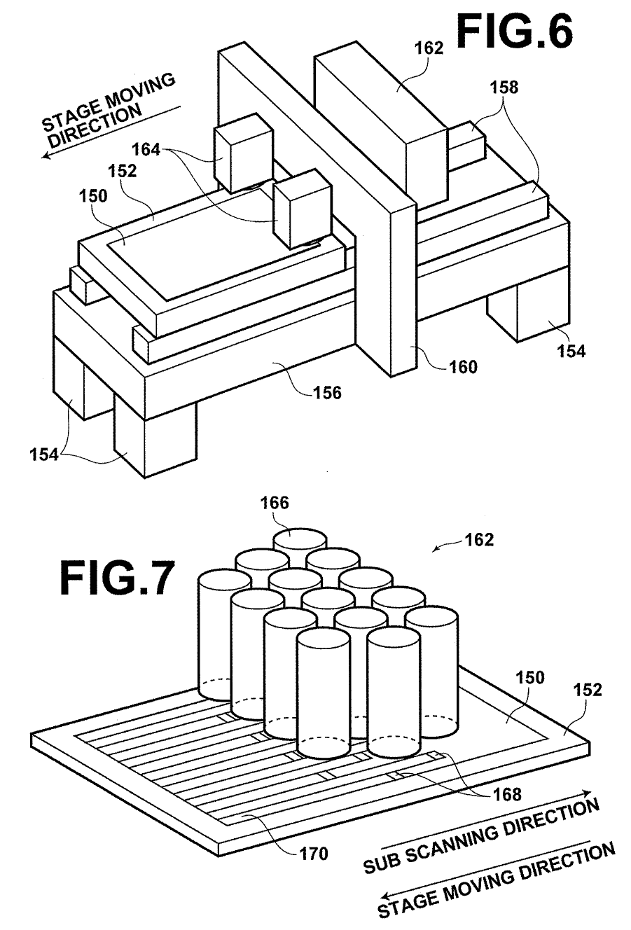

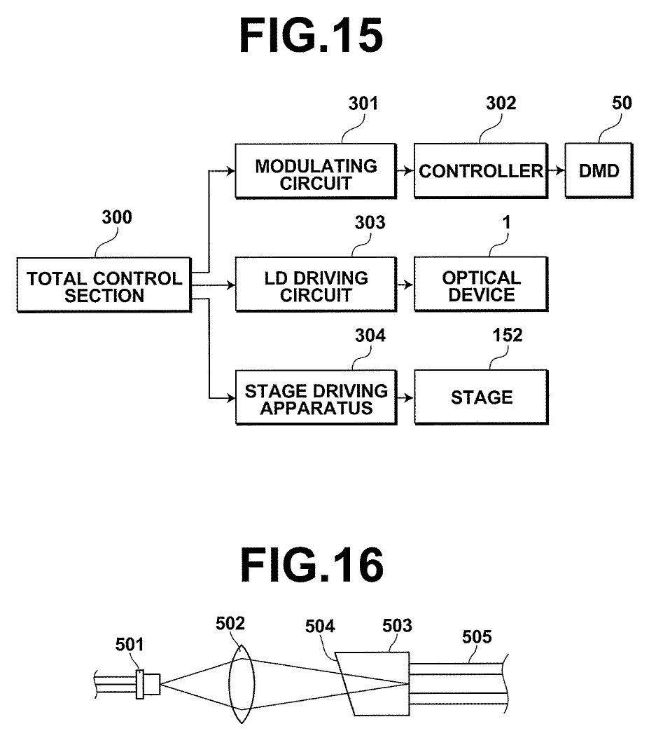

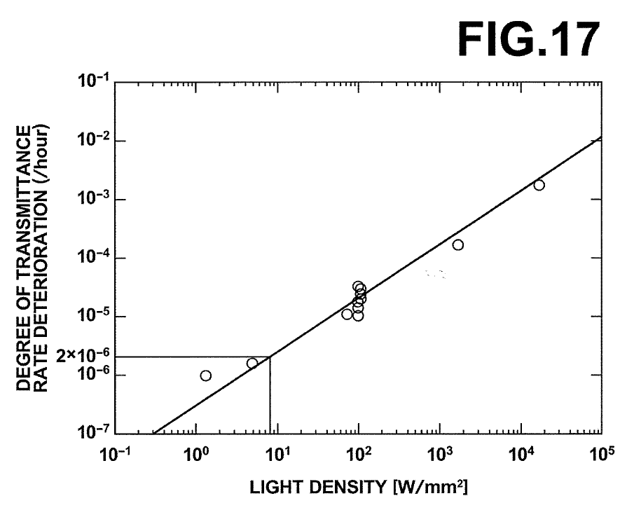

As illustrated in FIG. 6, the image exposure apparatus is equipped with a planar moving stage 152, for holding sheets of photosensitive material 150 thereon by suction. A mounting base 156 is supported by four legs 154. Two guides 158 that extend along the stage movement direction are provided on the upper surface of the mounting base 156. The stage 152 is provided such that its longitudinal direction is aligned with the stage movement direction, and supported by the guides 158 so as to be movable reciprocally thereon. Note that the image exposure apparatus is also equipped with a stage driving apparatus 304 (refer to FIG. 15), as a sub scanning means for driving the stage 152 along the guides 158.

A C-shaped gate 160 is provided at the central portion of the mounting base so as to straddle the movement path of the stage 152. The ends of the C-shaped gate 160 are fixed to side edges of the mounting base 156. A scanner 162 is provided on a first side of the gate 160, and a plurality (two, for example) of sensors 164 for detecting the leading and trailing ends of the photosensitive material 150 are provided on a second side of the gate 160. The scanner 162 and the sensors 164 are individually mounted on the gate 160, and fixed above the movement path of the stage 152. Note that the scanner 162 and the sensors 164 are connected to a controller (not shown) for controlling the operations thereof.

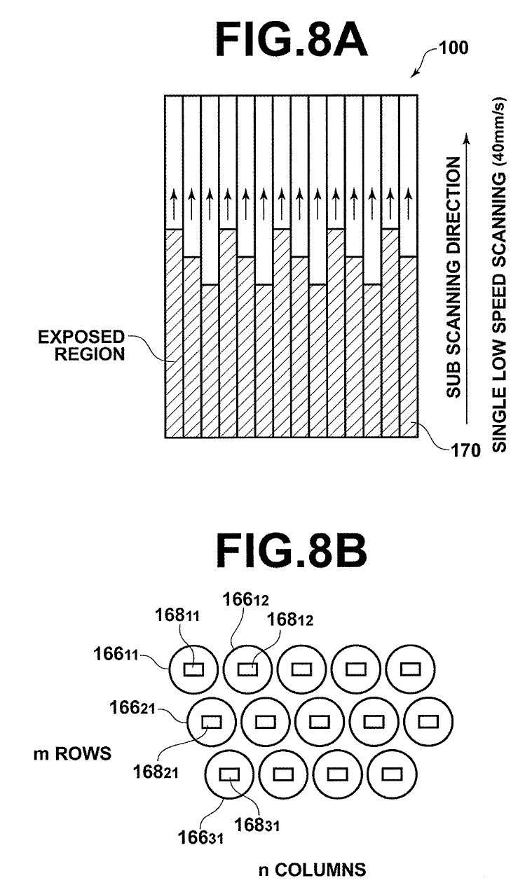

The scanner 162 is equipped with a plurality (14, for example) of exposure heads 166, arranged in an approximate matrix having m rows and n columns (3 rows and 5 columns, for example), as illustrated in FIG. 7 and FIG. 8B. In this example, four exposure heads 166 are provided in the third row, due to constraints imposed by the width of the photosensitive material 150. Note that an individual exposure head arranged in an m^{th} row and an n^{th} column will be denoted as an exposure head 166ₘₙ.

An exposure area 168, which is exposed by the exposure heads 166, is a rectangular area having its short sides in the sub-scanning direction. Accordingly, band-like exposed regions 170 are formed on the photosensitive material 150 by each of the exposure heads 166, accompanying the movement of the stage 152. Note that an individual exposure area, exposed by an exposure head arranged in an m^{th} row and an n^{th} column will be denoted as an exposure area 168_{m,n}.

As illustrated in FIG. 8A and FIG. 8B, each of the rows of the exposure heads 166 is provided staggered a predetermined interval (a natural number multiple of the long side of the exposure area, 2 times in the present embodiment) with respect to the other rows. This is to ensure that the band-like exposed regions 170 have no gaps therebetween in the direction perpendicular to the sub scanning direction. Therefore, the portion between an exposure area 168₁₁ and 168₁₂ of the first row, which cannot be exposed thereby, can be exposed by an exposure area 168₂₁ of the second row and an exposure area 168₃₁ of the third row.

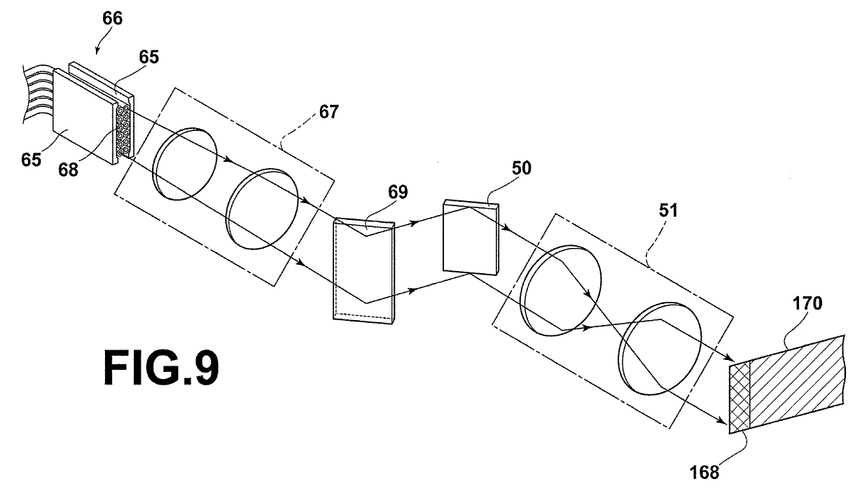

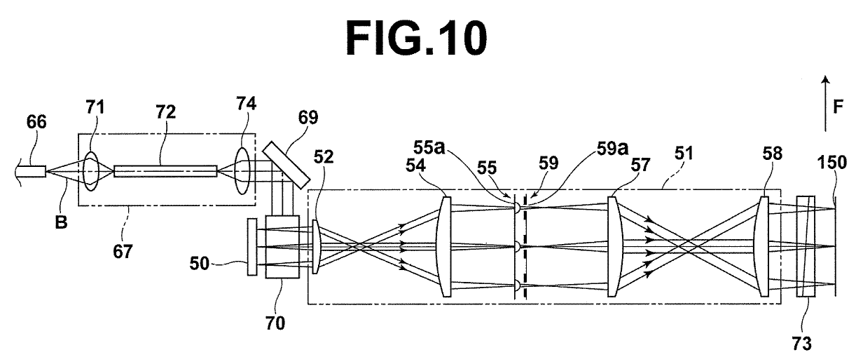

Each of the exposure heads 166₁₁ through 168ₘₙ are equipped with a DMD 50 (Digital Micro mirror Device) by Texas Instruments (U.S.), for modulating light beams incident thereon according to each pixel of image data, as illustrated in FIG. 9 and FIG. 10. The DMD's 50 are connected to a controller 302 to be described later (refer to FIG. 15), comprising a data processing section and a mirror drive control section. The data processing section of the controller 302 generates control signals for controlling the drive of each micro mirror of the DMD 50 within a region that should be controlled for each exposure head 166, based on input image data. Note that the “region that should be controlled” will be described later. The mirror drive control section controls the angle of a reflective surface of each micro mirror of the DMD 50 for each exposure head 166, according to the control signals generated by the data processing section. Note that control of the angle of the reflective surface will be described later.

A fiber array light source 66; an optical system 67; and a mirror 69 are provided in this order, at the light input side of the DMD 50. The fiber array light source 66 comprises a laser emitting section, constituted by a plurality of optical fibers having their light emitting ends (light emitting points) aligned in a direction corresponding to the longitudinal direction of the exposure area 168. The optical system 67 corrects laser beams emitted from the fiber array light source 66 to condense them onto the DMD 50. The mirror 69 reflects the laser beams, which have passed through the optical system 67, toward the DMD 50. Note that the optical system 67 is schematically illustrated in FIG. 9.

As illustrated in detail in FIG. 10, the optical system 67 comprises: a condensing lens 71, for condensing the laser beams B emitted from the fiber array light source 66 as illuminating light; a rod shaped optical integrator 72 (hereinafter, referred to simply as “rod integrator 72”), which is inserted into the optical path of the light which has passed through the condensing lens 71; and a collimating lens 74, provided downstream from the rod integrator 72, that is, toward the side of the mirror 69. The condensing lens 71, the rod integrator 72 and the collimating lens 74 cause the laser beams emitted from the fiber array light source to enter the DMD 50 as a light beam which is close to collimated light and which has uniform beam intensity across its cross section. The shape and the operation of the rod integrator 72 will be described in detail later.

The laser beam B emitted through the optical system 67 is reflected by the mirror 69, and is irradiated onto the DMD 50 via a TIR (Total Internal Reflection) prism 70. Note that the TIR prism 70 is omitted from FIG. 9.

A focusing optical system 51, for focusing the laser beam B reflected by the DMD 50 onto the photosensitive material 150, is provided on the light reflecting side of the DMD 50. The focusing optical system 51 is schematically illustrated in FIG. 4, but as illustrated in detail in FIG. 10, the focusing optical system 51 comprises: a first focusing optical system constituted by lens systems 52 and 54; a second focusing optical system constituted by lens systems 57 and 58; a micro lens array 55; and an aperture array 59. The micro lens array 55 and the aperture array 59 are provided between the first focusing optical system and the second focusing optical system.

The micro lens array 55 is constituted by a great number of micro lenses 55a, which are arranged two dimensionally, corresponding to each pixel of the DMD 50. In the present embodiment, only 1024×256 columns out of 1024×768 columns of micro mirrors of the DMD 50 are driven, as will be described later. Therefore, 1024×256 columns of micro lenses 55a are provided, corresponding thereto. The arrangement pitch of the micro lenses 55a is 41 μm in both the vertical and horizontal directions. The micro lenses 55a are formed by optical glass BK7, and have focal distances of 0.19 mm and NA's (Numerical Apertures) of 0.11, for example. Note that the shapes of the micro lenses 55a will be described in detail later. The beam diameter of each laser beams B at the position of each micro lens 55a is 41 μm.

The aperture array 59 has a great number of apertures 59a formed therethrough, corresponding to the micro lenses 55a of the micro lens array 55. In the present embodiment, the diameter of the apertures 59a is 10 μm.

The first focusing optical system magnifies the images that propagate thereto from the DMD 50 by 3× and focuses the images on the micro lens array 55. The second focusing optical system magnifies the images that have passed through the micro lens array 55 by 1.6×, and focuses the images onto the photosensitive material 150. Accordingly, the images from the DMD 50 are magnified at 4.8× magnification and projected onto the photosensitive material 150.

Note that in the present embodiment, a prism pair 73 is provided between the second focusing optical system and the photosensitive material 150. The focus of the image on the photosensitive material 150 is adjustable, by moving the prism pair 73 in the vertical direction in FIG. 10. Note that in FIG. 10, the photosensitive material 150 is conveyed in the direction of arrow F to perform sub-scanning.

The DMD 50 is a mirror device having a great number (1024×768, for example) of micro mirrors 62, each of which constitutes a pixel, arranged in a matrix on an SRAM cell 60 (memory cell). A micro mirror 62 supported by a support column is provided at the uppermost part of each pixel, and a material having high reflectivity, such as aluminum, is deposited on the surface of the micro mirror 62 by vapor deposition. Note that the reflectivity of the micro mirrors 62 is 90% or greater, and that the arrangement pitch of the micro mirrors 62 is 13.7 μm in both the vertical and horizontal directions. In addition, the CMOS SRAM cell 60 of a silicon gate, which is manufactured in a normal semiconductor memory manufacturing line, is provided beneath the micro mirrors 62, via the support column, which includes a hinge and a yoke. The DMD 50 is of a monolithic structure.

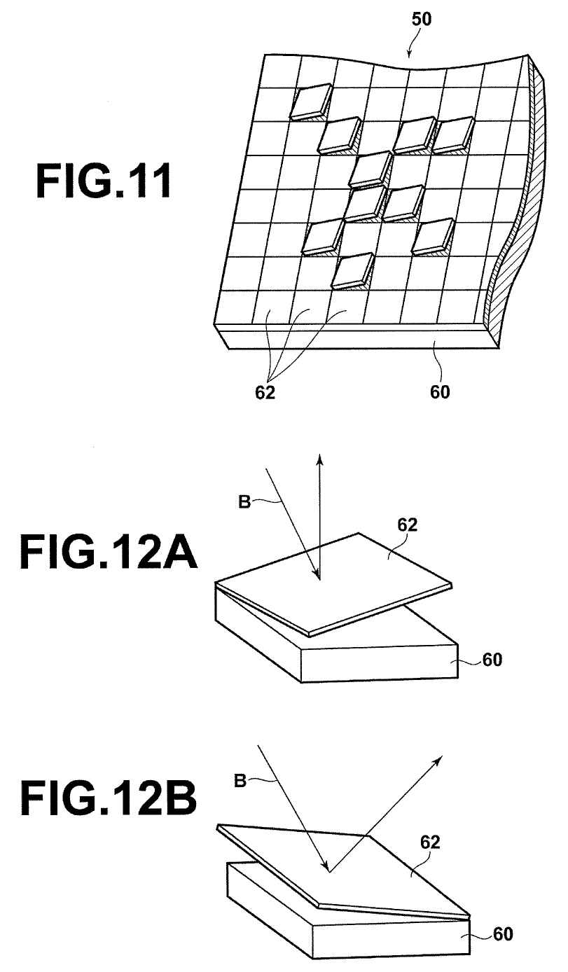

When digital signals are written into the SRAM cell 60 of the DMD 50, the micro mirrors 62 which are supported by the support columns are tilted within a range of ±α degrees (±12 degrees, for example) with respect to the substrate on which the DMD 50 is provided, with the diagonal line as the center of rotation. FIG. 12A illustrates a state in which a micro mirror 62 is tilted +α degrees in an ON state, and FIG. 12B illustrates a state in which a micro mirror 62 is tilted −α degrees in an OFF state. Accordingly, laser light beams incident on the DMD 50 are reflected toward the direction of inclination of each micro mirror 62, by controlling the tilt of each micro mirror 62 that corresponds to a pixel of the DMD 50 according to image signals, as illustrated in FIG. 11.

Note that FIG. 6 illustrates a magnified portion of a DMD 50 in which the micro mirrors 62 are controlled to be tilted at +α degrees and at −α degrees. The ON/OFF operation of each micro mirror 62 is performed by the controller 302, which is connected to the DMD 50. In addition, a light absorbing material (not shown) is provided in the direction toward which laser beams B reflected by micro mirrors 62 in the OFF state are reflected. The micro mirrors 62 of the present embodiment have distortions in their reflective surfaces. However, the distortions are omitted from FIGS. 11, 12A, and 12B.

It is preferable for the DMD 50 to be provided such that its short side is inclined at a slight predetermined angle (0.1° to 5°, for example) with respect to the sub-scanning direction. FIG. 8A illustrates scanning trajectories of reflected light images 53 (exposing beams) of each micro mirror in the case that the DMD 50 is not inclined, and FIG. 8B illustrates the scanning trajectories of the exposing beams 53 in the case that the DMD 50 is inclined.

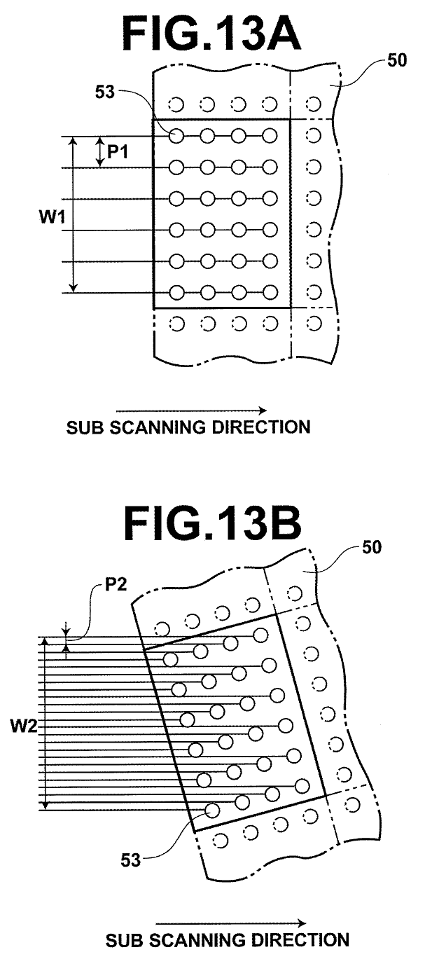

A great number (756, for example) of columns of rows of a great number (1024, for example) of micro mirrors aligned in the longitudinal direction, are provided in the lateral direction of the DMD 50. As illustrated in FIG. 13B, by inclining the DMD 50, the pitch P₂ of the scanning trajectories (scanning lines) of the exposure beams 53 become narrower than the pitch P₁ of the scanning lines in the case that the DMD 50 is not inclined. Therefore, the resolution of the image can be greatly improved. Meanwhile, because the angle of inclination of the DMD 50 is slight, the scanning width W₂ in the case that the DMD 50 is inclined and the scanning width W₁ in the case that the DMD is not inclined are substantially the same.

In addition, the same scanning lines are repeatedly exposed (multiple exposure) by different micro mirror columns. By performing multiple exposure in this manner, it becomes possible to finely control exposure positions with respect to alignment marks, and to realize highly detailed exposure. Seams among the plurality of exposure heads, which are aligned in the main scanning direction, can be rendered virtually seamless by finely controlling the exposure positions.

Note that the micro mirror columns may be shifted by predetermined intervals in the direction perpendicular to the sub-scanning direction to be in a staggered formation instead of inclining the DMD 50, to achieve the same effect.

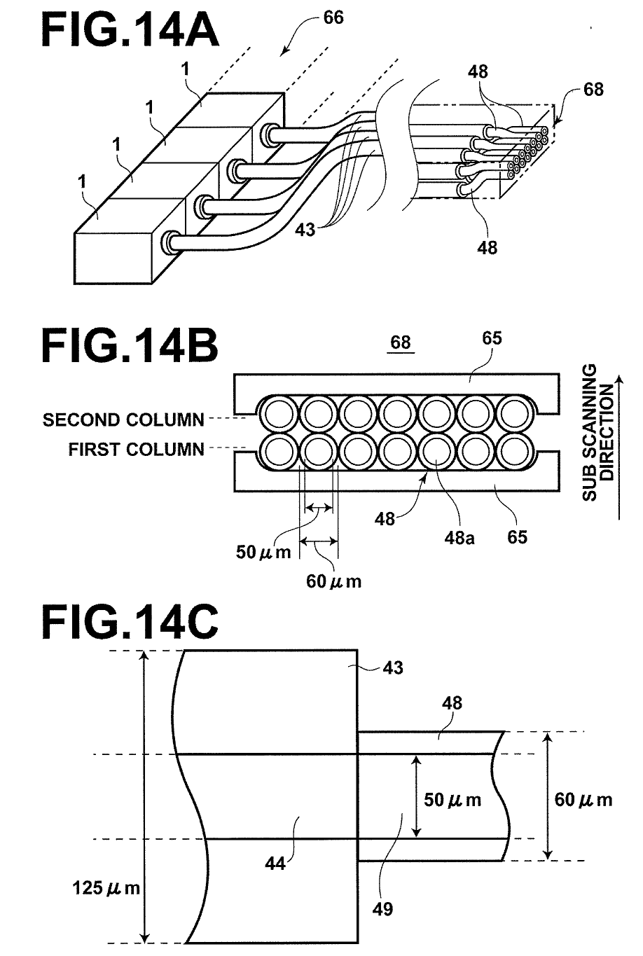

As illustrated in FIG. 14A, the fiber array light source 66 is equipped with a plurality (14, for example) of the optical devices 1 of FIG. 1. The CAN package 10 is provided at the end of each of the optical fibers 43 via the focusing lens 40, and second optical fibers 48 having the same core diameter as the optical fiber 43 and a cladding diameter smaller than that of the optical fiber 43, is coupled to the other end of each of the optical fibers 43. As illustrated in detail in FIG. 14B, the second optical fibers 48 are arranged such that seven ends of the optical fibers 30 opposite the end at which they are coupled to the optical fibers 43 are aligned along the main scanning direction perpendicular to the sub scanning direction. Two rows of the seven second optical fibers 48 constitute a laser emitting section 68.

As illustrated in FIG. 14B, the laser emitting section 68, constituted by the ends of the second optical fibers 48, is fixed by being sandwiched between two support plates 65, which have flat surfaces. It is desirable for a transparent protective plate, such as that made of glass, to be placed at the light emitting end surfaces of the second optical fibers 48. The light emitting end surfaces of the second optical fibers 48 are likely to collect dust due to their high optical density and therefore likely to deteriorate. However, by placing the protective plate as described above, adhesion of dust to the end surfaces can be prevented, and deterioration can be slowed.

In the present embodiment, as illustrated in FIG. 14C, the light output end surface of each optical fiber 43 having a large cladding diameter is coupled concentrically to the second optical fiber 48 having a small cladding diameter and a length of 1 cm to 30 cm. The optical fibers 43 and 48 are coupled such that the light input end surfaces of the second optical fibers 48 are fused to the light output end surfaces of the optical fibers 43 in a state that the core axes thereof are matched. As described above, the diameter of the cores 49 of the second optical fibers 48 are the same as the diameters of the cores 44 of the optical fibers 43.

Next, the electric configuration of the image exposure apparatus of the present embodiment will be described with reference to FIG. 15. As illustrated in FIG. 15, a modulating circuit 301 is connected to a total control section 300, and a controller 302 for controlling the DMD's 50 is connected to the modulating circuit 301. An LD drive circuit 303 for driving the optical devices 1 is connected to the total control section 300. Further, a stage driving apparatus 304 for driving the stage 152 is connected to the total control section 300.

### [Operation of the Image Exposure Apparatus]

Next, the operation of the image exposure apparatus described above will be described. IN each exposure head 166 of the scanner 162, the laser beams B are emitted by each of the GaN semiconductor lasers LD of the CAN packages 10 (refer to FIG. 1) that constitute the multiplex laser light source of the fiber array light source 66 in a diffuse state. The laser beams B are focused by the focusing lenses 40, pass through the transparent members 42 and converge on the light input end surfaces of the cores 44 of the optical fibers 43. The laser beams B that enter the cores 44 of the optical fibers 43 are output from the second optical fibers 48, which are coupled to the light output end surfaces of the optical fibers 43.

During image exposure, image data corresponding to an exposure pattern is input to the controller 302 of the DMD's 50 from the modulating circuit 301 of FIG. 15. The image data is temporarily stored in a frame memory of the controller 302. The image data represents the density of each pixel that constitutes an image as binary data (dot to be recorded/dot not to be recorded).

The stage 152, on the surface of which the photosensitive material 150 is fixed by suction, is conveyed along the guides 158 from the upstream side to the downstream side of the gate 160 by the stage driving apparatus 304 illustrated in FIG. 15. When the stage 152 passes under the gate 160, the leading edge of the photosensitive material is detected by the sensors 164, which are mounted on the gate 160. Then, the image data recorded in the frame memory is sequentially read out a plurality of lines at a time. Control signals are generated by the signal processing section for each exposure head 166, based on the read out image data. Thereafter, the mirror driving control section controls the ON/OFF states of each micro mirror of the DMD's 50 of each exposure head, based on the generated control signals. Note that in the present embodiment, the size of each micro mirror that corresponds to a single pixel is 14 μm×14 μm.

When the laser beams B are irradiated onto the DMD's 50 from the fiber array light source 66, laser beams which are reflected by micro mirrors in the ON state are focused on the photosensitive material 150 by the lens systems 54 and 58. The laser beams emitted from the fiber array light source 66 are turned ON/OFF for each pixel, and the photosensitive material 150 is exposed in pixel units (exposure areas 168) substantially equal to the number of pixels of the DMD's 50 in this manner. The photosensitive material 150 is conveyed with the stage 152 at the constant speed. Sub-scanning is performed in the direction opposite the stage moving direction by the scanner 162, and band-shaped exposed regions 170 are formed on the photosensitive material 150 by each exposure head 166.

When sub scanning of the photosensitive material 150 by the scanner 162 is completed and the trailing edge of the photosensitive material 150 is detected by the sensors 162, the stage 152 is returned to its starting point at the most upstream side of the gate 160 along the guides 152 by the stage driving apparatus 304. Then, the stage 152 is moved from the upstream side to the downstream side of the gate 160 at the constant speed again.

Next, an illuminating optical system for irradiating the laser beam B onto the DMD's 50, comprising: the fiber array 66, the condensing lens 71, the rod integrator 72, the collimating lens 74, the mirror 69, and the TIR prism 70 illustrated in FIG. 10 will be described. The rod integrator 72 is a light transmissive rod, formed as a square column, for example. The laser beam B propagates through the interior of the rod integrator 72 while being totally reflected therein, and the intensity distribution within the cross section of the laser beam B is uniformized. Note that an anti-reflective film is coated on the light input surface and the light emitting surface of the rod integrator 72, to increase the transmissivity thereof. By uniformizing the intensity distribution within the cross section of the laser beam B in this manner, unevenness in the intensity of the illuminating light can be eliminated, and highly detailed images can be exposed on the photosensitive material 150.

What is claimed is:

1. An optical device, comprising:
light emitting means constituted by: a light emitting element that emits a light beam having a wavelength within a range from 220 nm to 500 nm at an output of 230 mW or greater; a housing having a window that contains the light emitting element in a sealed state therein; and a first transparent member, which is transparent with respect to the light beam, that seals the window; and
a focusing optical system that focuses the light emitted by the light emitting element and output through the first transparent member;
the light density of the light beam being 1.15 W/mm² or less at the light output surface of the first transparent member.

2. An optical device as defined in claim 1, wherein:
the first transparent member is fitted into the window, and protrudes toward the exterior of the housing.

3. An optical device as defined in claim 1, wherein:
the first transparent member abuts the housing at the exterior thereof.

4. An optical device as defined in claim 1, further comprising:
an optical fiber provided such that the light which is focused by the focusing optical system enters thereinto.

5. An optical device as defined in claim 4, further comprising:
a second transparent member, which is transparent with respect to the light beam, provided between a light input surface of the optical fiber and the focusing optical system; and wherein:
the optical fiber is configured to be removably attached to the second transparent member, and optically positioned by abutting the second transparent member.

6. An optical device as defined in claim 5, further comprising:
a coupling preventing film formed by a fluoride material and having a thickness less than or equal to 1/12 the wavelength of the light beam, provided on one of the light output surface of the second transparent member and the light input surface of the optical fiber.

7. An optical device as defined in claim 1, wherein:
the light emitting element is a semiconductor laser.

8. An optical device as defined in claim 7, wherein:
the housing is a 9 mm diameter CAN package.

9. An image exposure apparatus equipped with the optical device defined in claim 1 as an exposure light-source.
